(19) United States
(12) Patent Application Publication
(10) Pub. No.: US 2026/0181673 A1
(43) Pub. Date: Jun. 25, 2026

(54) Sidelink Communication with Multiple Feedback Resources

(71) Applicant: TELEFONAKTIEBOLAGET LM ERICSSON (PUBL), Stockholm (SE)

(72) Inventors: Zhang Zhang, Beijing (CN); Min Wang, Luleå (SE); Jan Christoffersson, Luleå (SE)

(21) Appl. No.: 19/125,954

(22) PCT Filed: Nov. 2, 2023
(86) PCT No.: PCT/CN2023/129324

§ 371 Date: Apr. 30, 2025

(30) Foreign Application Priority Data
Nov. 11, 2022 (WO) PCT/CN2022/131312

(51) Int. Cl. H04W 72/25; H04L 1/1812

(52) U.S. Cl. CPC H04W 72/25; H04L 1/1812

(57) ABSTRACT

The present disclosure is related to UEs, a network node, and methods for sidelink communication with multiple feedback resources. A method at a UE for performing SL communication, which is scheduled by a network node, with one or more other UEs comprises: transmitting, to the one or more other UEs, a first message associated with a first SL HARQ process over a first SL resource scheduled by the network node; and waiting for SL HARQ feedback for the first message from the one or more other UEs over one or more second SL resources associated with the transmission of the first message.

### CROSS-REFERENCE TO RELATED APPLICATION(S)

This application claims priority to the PCT International Application No. PCT/CN2022/131312, entitled “SIDELINK COMMUNICATION WITH MULTIPLE FEEDBACK RESOURCES”, filed on Nov. 11, 2022, which is incorporated herein by reference in its entirety.

### TECHNICAL FIELD

The present disclosure is related to the field of telecommunication, and in particular, to User Equipments (UEs), a network node, and methods for sidelink (SL) communication with multiple feedback resources.

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink communications. Sidelink is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G NR standard. These new cellular services were motivated by the business and economic needs of making the 3^{rd} Generation Partnership Project (3GPP) ecosystem capable of supporting industrial requirements ranging from direct automotive communication between vehicles to industrial automation with Ultra-Reliable Low-Latency Communication (URLLC) for mission- and business-critical applications. But these same technologies can also be used for consumers to enhance their communication experience. For instance, sidelink proximity services would allow devices to discover and communicate with one another at extremely high data rates and low latency, making them ideal for peer-to-peer gaming and streaming services as well as enhanced Augmented Reality (AR), Virtual Reality (VR), and other wearable device communications.

In contrast with uplink and downlink between a UE and a base station, where resource allocation and link adaptation are controlled by the network, in sidelink the device performs both functions autonomously. In other words, the device gains more control of how to use network resources. Sidelink is also a candidate for future releases as an Industrial Internet of Things (IoT) enabler. By restricting the communication link to one hop, latency is greatly reduced, which is key to mission-critical industrial applications. Furthermore, sidelink is a potential solution for public safety ensuring direct communication or relayed communication between devices.

Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide-area, local-area and personal-area communications.

### SUMMARY

According to a first aspect of the present disclosure, a method at a UE for performing SL communication, which is scheduled by a network node, with one or more other UEs is provided. The method comprises: transmitting, to the one or more other UEs, a first message associated with a first SL Hybrid Automatic Repeat Request (HARQ) process over a first SL resource scheduled by the network node; and waiting for SL HARQ feedback for the first message from the one or more other UEs over one or more second SL resources associated with the transmission of the first message.

In some embodiments, the method further comprises: determining whether the UE is still waiting for the SL HARQ feedback for the first message over at least one of the one or more second SL resources or not. In some embodiments, the step of determining whether the UE is still waiting for the SL HARQ feedback for the first message over at least one of the one or more second SL resources or not comprises: determining whether the SL HARQ feedback for the first message has been received or not; determining whether at least one of the one or more second SL resources is still available for the SL HARQ feedback or not; and determining that the UE is still waiting for the SL HARQ feedback for the first message over the at least one of the one or more second SL resources in response to determining that the SL HARQ feedback for the first message has not been received from at least one of the one or more other UEs and in response to determining that the at least one of the one or more second SL resources is still available for the SL HARQ feedback. In some embodiments, the method further comprises: determining that the UE is not waiting for the SL HARQ feedback for the first message over the at least one of the one or more second SL resources in response to determining that the SL HARQ feedback for the first message has been received from all of the one or more other UEs and/or in response to determining that none of the second SL resources is still available for the SL HARQ feedback.

In some embodiments, before the step of determining whether the UE is still waiting for the SL HARQ feedback for the first message over at least one of the one or more second SL resources or not, the method further comprises: receiving, from the network node, a message indicating one or more third SL resources for retransmission of the first message. In some embodiments, the method further comprises at least one of: ignoring at least one of the one or more third SL resources in response to determining that the UE is still waiting for the SL HARQ feedback over at least one of the one or more second SL resources; and transmitting a second message associated with a second SL HARQ process, which is different from the first SL HARQ process, over the one or more third SL resources when the UE is allowed and/or configured to select a HARQ process for its transmission by itself. In some embodiments, before the step of transmitting the second message, the method further comprises: selecting, as the second SL HARQ process, one of SL HARQ processes in a following listed order, the SL HARQ processes comprising at least one of: an SL HARQ process where SL HARQ feedback for the latest SL transmission associated with the SL HARQ process has not been received, there is no more available SL resource for the SL HARQ feedback, and associated retransmission is to be performed; an SL HARQ process where negative SL HARQ feedback for the latest SL transmission associated with the SL HARQ process has been received and associated retransmission is to be performed; and an SL HARQ process with no buffered SL traffic to be transmitted or retransmitted or an SL HARQ process where positive SL HARQ feedback for the latest SL transmission associated with the SL HARQ process has been received and initial transmission and one or more subsequent retransmissions are to be performed.

In some embodiments, the method further comprises, in response to determining that the UE is still waiting for the SL HARQ feedback for the first message over the at least one of the one or more second SL resources, at least one of: preventing a HARQ feedback for the first message from being transmitted to the network node; transmitting, to the network node, a message indicating a negative HARQ feedback for the first message; and transmitting, to the network node, a message indicating that the UE is waiting for SL HARQ feedback from at least one of the one or more other UEs for the first message. In some embodiments, the message indicating that the UE is waiting for SL HARQ feedback from at least one of the one or more other UEs for the first message is Uplink Control Information (UCI) or a Medium Access Control (MAC) Control Element (CE). In some embodiments, the message indicating that the UE is waiting for SL HARQ feedback from at least one of the one or more other UEs for the first message further indicates an identifier (ID) of the first SL HARQ process.

In some embodiments, the method further comprises, in response to determining that the UE is not waiting for the SL HARQ feedback for the first message over the at least one of the one or more second SL resources, at least one of: transmitting, to the network node, a message indicating a negative HARQ feedback for the first message; transmitting, to the network node, a message indicating a negative HARQ feedback for the first message when the transmission of the first message is a unicast transmission or a groupcast transmission with HARQ option 2; and transmitting, to the network node, a message indicating a positive HARQ feedback for the first message when the transmission of the first message is a groupcast transmission with HARQ option 1.

In some embodiments, when there are multiple second SL resources available for the UE to detect SL HARQ feedback, the method further comprises: receiving, from the network node, a message indicating multiple uplink (UL) resources for the UE to transmit, to the network node, HARQ feedback for the first message. In some embodiments, the number of the multiple UL resources is less than or equal to the number of the multiple second SL resources. In some embodiments, the last one of the multiple UL resources occurs later than the last one of the multiple second SL resources, and the non-last ones of the multiple UL resources occur between the first one and the last one of the multiple second SL resources. In some embodiments, for a non-last one of the multiple UL resources, the method further comprises, in response to determining that the SL HARQ feedback for the first message has not been received from at least one of the one or more other UEs before the non-last UL resource, at least one of: preventing a HARQ feedback for the first message from being transmitted to the network node; transmitting, to the network node over the non-last one of the multiple UL resources, a message indicating a negative HARQ feedback for the first message; and transmitting, to the network node over the non-last one of the multiple UL resources, a message indicating that the UE is waiting for SL HARQ feedback from at least one of the one or more other UEs for the first message. In some embodiments, for a non-last one of the multiple UL resources, the method further comprises: transmitting, to the network node, a message indicating HARQ feedback for the first message over the non-last one of the multiple UL resources based on at least the SL HARQ feedback for the first message in response to determining that the SL HARQ feedback for the first message has been received from all of the one or more other UEs before the non-last UL resource. In some embodiments, for the last one of the multiple UL resources, the method further comprises, in response to determining that the SL HARQ feedback for the first message has not been received from at least one of the one or more other UEs over all of the multiple second SL resources, at least one of: transmitting, to the network node, a message indicating a negative HARQ feedback for the first message over the last one of the multiple UL resources; and transmitting, to the network node, a message indicating a negative HARQ feedback for the first message over the last one of the multiple UL resources when the transmission of the first message is a unicast transmission or a groupcast transmission with HARQ option 2; and transmitting, to the network node, a message indicating a positive HARQ feedback for the first message over the last one of the multiple UL resources when the transmission of the first message is a groupcast transmission with HARQ option 1. In some embodiments, for the last one of the multiple UL resources, the method further comprises: transmitting, to the network node, a message indicating HARQ feedback for the first message over the last one of the multiple UL resources based on at least the SL HARQ feedback for the first message in response to determining that the SL HARQ feedback for the first message has been received from all of the one or more other UEs over at least one of the one or more second SL resources.

In some embodiments, the method further comprises: receiving, from the network node, a fifth message indicating one or more fourth SL resources for transmission associated with a third SL HARQ process different from the first SL HARQ process, and the method further comprises at least one of: dropping remaining resources associated with the first SL HARQ process; and continuing to use the remaining resources associated with the first SL HARQ process for retransmission associated with the first SL HARQ process when retransmission needs to be performed. In some embodiments, whether the UE drops remaining resources associated with the first SL HARQ process and/or whether the UE continues to use the remaining resources is determined in at least one of followings way: configured by the network node; preconfigured at the UE; and hard coded in the specification. In some embodiments, at least one of following is true: the first SL resource is a resource for Physical Sidelink Control Channel (PSCCH) and/or Physical Sidelink Shared Channel (PSSCH) transmission; the one or more second SL resources are Physical Sidelink Feedback Channel (PSFCH) occasions; the one or more third SL resources are resources for PSSCH transmission; the one or more fourth SL resources are resources for PSSCH transmission; and the multiple UL resources are resources for Physical Uplink Control Channel (PUCCH) and/or Physical Uplink Shared Channel (PUSCH) transmission.

According to a second aspect of the present disclosure, a UE is provided. The UE comprises: a processor; a memory storing instructions which, when executed by the processor, cause the processor to perform any of the methods of the first aspect.

According to a third aspect of the present disclosure, a UE for performing SL communication, which is scheduled by a network node, with one or more other UEs is provided. The UE comprises: a transmitting module configured to transmit, to the one or more other UEs, a first message associated with a first SL HARQ process over a first SL resource scheduled by the network node; and a waiting module configured to wait for SL HARQ feedback for the first message from the one or more other UEs over one or more second SL resources associated with the transmission of the first message. In some embodiments, the UE may comprise one or more further modules, each of which may perform any of the steps of any of the methods of the first aspect.

According to a fourth aspect of the present disclosure, a method at a network node for facilitating a UE in performing SL communication, which is scheduled by the network node, with one or more other UEs is provided. The method comprises: scheduling the UE to transmit a first message to the one or more other UEs over a first SL resource; determining whether the UE is waiting for SL HARQ feedback for the first message or not; and performing one or more operations based on at least the determination.

In some embodiments, the one or more operations comprise at least one of: ignoring HARQ feedback received from the UE for the first message in response to determining that the UE is still waiting for the SL HARQ feedback for the first message; preventing a new SL grant from being issued to the UE for retransmission of the first message in response to determining that the UE is still waiting for the SL HARQ feedback for the first message; and issuing a new SL grant to the UE for transmission of a second message different from the first message in response to determining that the UE is still waiting for the SL HARQ feedback for the first message; and issuing a new SL grant to the UE for retransmission of the first message in response to determining that the UE is not waiting for the SL HARQ feedback for the first message. In some embodiments, the step of determining that the UE is still waiting for SL HARQ feedback for the first message comprises at least one of: receiving, from the UE, a message indicating that the UE is waiting for SL HARQ feedback from at least one of the one or more other UEs for the first message; determining that the network node has not received HARQ feedback for the first message that should have been transmitted in the first SL resource and that there is still at least one second SL resource available for SL HARQ feedback associated to the first SL resource and/or at least one UL resource available for HARQ feedback associated to the first SL resource.

In some embodiments, the step of determining that the UE is not waiting for SL HARQ feedback for the first message comprises: determining that the network node has not received positive HARQ feedback for the first message that should have been transmitted in the first SL resource and that there is no second SL resource available for SL HARQ feedback associated to the first SL resource and/or no UL resource available for HARQ feedback associated to the first SL resource. In some embodiments, the determination of whether the UE is waiting for SL HARQ feedback for the first message or not is performed at a time before which the latest SL resource granted by the network node to the UE is the first SL resource. In some embodiments, the one or more operations are performed only when there is no more preserved resource for the first message after the step of determining whether the UE is waiting for SL HARQ feedback for the first message or not.

In some embodiments, a counter is maintained at the network node for an SL HARQ process for the UE. In some embodiments, the counter is used by the network node to determine whether there is still at least one second SL resource available for SL HARQ feedback associated to a granted SL resource delivered to the SL HARQ process or not. In some embodiments, the counter is initially set to 0 and reset to 0 after each granted SL resource delivered to the SL HARQ process occurs, and/or wherein the counter is increased by one after each second SL resource for SL HARQ feedback associated to a granted SL resource delivered to the SL HARQ process occurs. In some embodiments, the step of determining whether there is still at least one second SL resource available for SL HARQ feedback associated to a granted SL resource delivered to the SL HARQ process comprises: determining whether the counter has a value less than a total number of second SL resources for SL HARQ feedback associated to the granted SL resource or not. In some embodiments, the step of determining whether there is still at least one second SL resource available for SL HARQ feedback associated to the granted SL resource further comprises at least one of: determining that there is still at least one second SL resource available for SL HARQ feedback associated to the granted SL resource in response to determining that the counter has a value less than the total number of second SL resources for SL HARQ feedback associated to the granted SL resource; and determining that there is no second SL resource available for SL HARQ feedback associated to the granted SL resource in response to determining that the counter has a value equal to or greater than the total number of second SL resources for SL HARQ feedback associated to the granted SL resource. In some embodiments, at least one of following is true: the first SL resource is a resource for PSCCH and/or PSSCH transmission; the at least one second SL resource is PSFCH occasions; and the at least one UL resource is a resource for PUCCH and/or PUSCH transmission.

According to a fifth aspect of the present disclosure, a network node is provided. The network node comprises: a processor; a memory storing instructions which, when executed by the processor, cause the processor to perform any of the methods of the fourth aspect.

According to a sixth aspect of the present disclosure, a network node for facilitating a UE in performing SL communication, which is scheduled by the network node, with one or more other UEs is provided. The network node comprises: a scheduling module configured to schedule the UE to transmit a first message to the one or more other UEs over a first SL resource; a determining module configured to determine whether the UE is waiting for SL HARQ feedback for the first message or not; and a performing module configured to perform one or more operations based on at least the determination. In some embodiments, the network node may comprise one or more further modules, each of which may perform any of the steps of any of the methods of the fourth aspect.

According to a seventh aspect of the present disclosure, a method at a UE for performing SL communication with another UE is provided. The method comprises: receiving, from the other UE, a first message associated with a first SL HARQ process over a first SL resource; and starting a first timer having a length that is determined based on at least multiple second SL resources for SL HARQ feedback for the first message; and performing one or more operations based on at least the first timer.

In some embodiments, the length of the first timer is determined based on a time distance between the multiple second SL resources. In some embodiments, the length of the first timer is determined as a time distance between one of the second SL resources that occurs the earliest and another of the second SL resources that occurs the latest. In some embodiments, the step of starting the first timer is performed upon the end of one of the second SL resources that occurs the earliest when SL HARQ feedback is enabled. In some embodiments, the one or more operations comprise at least one of: stopping the first timer upon the end of one of the second SL resources over which a positive SL HARQ feedback is transmitted to the other UE when SL HARQ feedback is enabled; starting a second timer upon the end of one of the second SL resources when SL HARQ feedback is enabled and the SL HARQ feedback for the first message is transmitted to the other UE in that second SL resource; starting the second timer upon the end of one of the second SL resources when SL HARQ feedback is enabled and the first timer expires; and starting a third timer upon the second timer expires and the received first message is not correctly decoded. In some embodiments, the method further comprises at least one of: starting the second timer upon the end of the reception of the first message when SL HARQ feedback is disabled. In some embodiments, at least one of following is true: the first SL resource is a resource for PSCCH and/or PSSCH transmission; the multiple second SL resources are PSFCH occasions; the first timer is sl-drx-HARQ-PSFCH-Timer, the second timer is sl-drx-HARQ-RTT-Timer, and the third timer is sl-RetransmissionTimer and/or sl-DRX-GC-RetransmissionTimer.

According to an eighth aspect of the present disclosure, a UE is provided. The UE comprises: a processor; a memory storing instructions which, when executed by the processor, cause the processor to perform any of the methods of the seventh aspect.

According to a ninth aspect of the present disclosure, a UE for performing SL communication with another UE is provided. The UE comprises: a receiving module configured to receive, from the other UE, a first message associated with a first SL HARQ process over a first SL resource; a starting module configured to start a first timer having a length that is determined based on at least multiple second SL resources for SL HARQ feedback for the first message; and a performing module configured to perform one or more operations based on at least the first timer. In some embodiments, the UE may comprise one or more further modules, each of which may perform any of the steps of any of the methods of the seventh aspect.

According to a tenth aspect of the present disclosure, a computer program comprising instructions is provided. The instructions, when executed by at least one processor, cause the at least one processor to carry out any of the methods of the first, fourth, or seventh aspect.

According to an eleventh aspect of the present disclosure, a carrier containing the computer program of the tenth aspect. In some embodiments, the carrier is one of an electronic signal, optical signal, radio signal, or computer readable storage medium.

According to a twelfth aspect of the present disclosure, a telecommunication system is provided. The telecommunication system comprises: one or more UEs of the second or third aspect; at least one network node of the fifth or sixth aspect; and one or more UEs of the eighth or ninth aspect.

### BRIEF DESCRIPTION OF THE DRAWINGS

FIG. 1 is a diagram illustrating an exemplary network in which SL communication with multiple feedback resources may be applicable according to an embodiment of the present disclosure.

FIG. 2 is a flow chart illustrating an exemplary method at a UE for performing SL communication, which is scheduled by a network node, with one or more other UEs according to an embodiment of the present disclosure.

FIG. 3 is a flow chart illustrating an exemplary method at a network node for facilitating a UE in performing SL communication, which is scheduled by the network node, with one or more other UEs according to an embodiment of the present disclosure.

FIG. 4 is a flow chart illustrating an exemplary method at a UE for performing SL communication with another UE according to an embodiment of the present disclosure.

FIG. 5 schematically shows an embodiment of an arrangement which may be used in UEs or a network node according to an embodiment of the present disclosure.

FIG. 6 is a block diagram of an exemplary UE according to an embodiment of the present disclosure.

FIG. 7 is a block diagram of an exemplary network node according to an embodiment of the present disclosure.

FIG. 8 is a block diagram of another exemplary UE according to another embodiment of the present disclosure.

FIG. 9 shows an example of a communication system in accordance with some embodiments of the present disclosure.

FIG. 10 shows an exemplary UE in accordance with some embodiments of the present disclosure.

FIG. 11 shows an exemplary network node in accordance with some embodiments of the present disclosure.

FIG. 12 is a block diagram of an exemplary host, which may be an embodiment of the host of FIG. 9, in accordance with various aspects described herein.

FIG. 13 is a block diagram illustrating an exemplary virtualization environment in which functions implemented by some embodiments may be virtualized.

FIG. 14 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as sidelink communication with multiple feedback resources is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents.

Further, following 3GPP documents are incorporated herein by reference in their entireties:
3GPP TS 37.213 V17.2.0 (2022-06), Technical Specification, 3^{rd} Generation Partnership Project; Technical Specification Group Radio Access Network; Physical layer procedures for shared spectrum channel access (Release 17);
3GPP TS 38.212 V17.2.0 (2022-06), Technical Specification, 3^{rd} Generation Partnership Project; Technical Specification Group Radio Access Network; NR; Multiplexing and channel coding (Release 17); and
3GPP TS 38.321 V17.2.0 (2022-09), Technical Specification, 3^{rd} Generation Partnership Project; Technical Specification Group Radio Access Network; NR; Medium Access Control (MAC) protocol specification (Release 17).

In order to tackle with the ever increasing data demanding, NR is supported on both licensed and unlicensed spectrum (i.e., referred to as NR-U). Compared to the LTE License-Assisted Access (LAA), NR-U supports Dual Connectivity (DC) and standalone scenarios, where the MAC procedures including Random Access Channel (RACH) and scheduling procedure on unlicensed spectrum are subject to the Listen Before Talk (LBT) failures, while there was no such restriction in LTE LAA, since there was licensed spectrum in LAA scenario so the RACH and scheduling related signalling can be transmitted on the licensed spectrum instead of unlicensed spectrum.

Access to a channel in the unlicensed spectrum, especially in the 5 GHZ and 6 GHz band, is guaranteed by LBT requirements defined by regulations, unlike licensed spectrum which is assigned to a specific operator.

The LBT mechanism mandates a device to sense for the presence of other users' transmissions in the channel before attempting to transmit. The device performs clear channel assessment (CCA) checks on the channel using energy detection (ED) before transmitting. If the channel is found to be idle, i.e. energy detected is below a certain threshold, the device is allowed to transmit. Otherwise, if the channel is found to be occupied (i.e., LBT is failed), the device must defer transmitting. This mechanism reduces interferences and collisions to other systems and increases probabilities of successful transmissions. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

NR-U supports two different LBT modes, dynamic and semi-static channel occupancy for two types of equipment, Load based Equipment (LBE) and Frame based equipment (FBE), respectively.

3GPP specified the LTE D2D (device-to-device) technology, also known as sidelink (SL) or the PC5 interface, as part of Release 12 (Rel-12). The target use case was the Proximity Services (communication and discovery). Support was enhanced during Rel-13. In Rel-14, the LTE sidelink was extensively redesigned to support vehicular communications (commonly referred to as V2X or V2V). Support was again enhanced during Rel-15. From the point of view of the lowest radio layers, the LTE SL uses broadcast communication. That is, transmission from a UE targets any receiver that is in range.

In Rel-16, 3GPP introduced sidelink for the 5G new radio (NR). The driving use case was vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver. HARQ feedback based retransmission is supported for unicast and groupcast.

NR SL introduces 2 stage sidelink control information (SCI), the 1^{st} stage SCI is transmitted on PSCCH and used for the scheduling of PSSCH and 2^{nd} stage SCI on PSSCH. PSCCH carrying 1^{st} stage SCI and the PSSCH scheduled by the 1^{st} stage SCI are transmitted in the same slot but in different symbols.

NR sidelink transmissions have the following two modes of resource allocations:
Mode 1: Sidelink resources are scheduled by the gNB, including both dynamic scheduling and configured grant.
Mode 2: The UE autonomously selects sidelink resources from a (pre-) configured sidelink resource pool(s) based on the channel sensing mechanism.

For Radio Resource Control (RRC) CONNECTED UE, a UE can be configured to adopt either Mode 1 or Mode 2 resource allocation (RA). In other cases, only Mode 2 can be adopted. Furthermore, a RRC CONNECTED mode 2 UE uses dedicated Tx resource pool configured by the gNB using dedicated RRC signalling, an RRC IDLE/INACTIVE mode 2 UE selects a common Tx resource pool to use from the set of common Tx resource pools configured by the gNB using common RRC signalling, an out of coverage mode 2 UE selects a common Tx resource pool to use from the set of preconfigured common Tx resource pools.

For both mode 1 dynamic scheduling and mode 2 RA, multiple resources may be preserved for transmission of the same transport block (TB), currently at most 3 resources can be preserved for transmission of the same TB by one SCI (i.e., one initial transmission plus two retransmissions).

In some embodiments, for Sidelink HARQ feedback handling, the MAC entity shall for each PSSCH transmission:
1. If an acknowledgement corresponding to the PSSCH transmission is obtained from the physical layer [2]:
   2. Deliver the acknowledgement to the corresponding Sidelink HARQ entity for the Sidelink process;
1. Else:
   2. deliver a negative acknowledgement to the corresponding Sidelink HARQ entity for the Sidelink process

In some embodiments, for mode 1 RA, if sl-PUCCH-Config is configured, the MAC entity shall for a PUCCH transmission occasion:
1. if a MAC PDU has been obtained for a sidelink grant associated to the PUCCH transmission occasion, the MAC entity shall:
   2. if the most recent transmission of the MAC PDU was not prioritized (thus the transmission is not performed):
      3. instruct the physical layer to signal a negative acknowledgement on the PUCCH (to the gNB).
   2. else if HARQ feedback has been disabled for the MAC PDU and next retransmission(s) of the MAC PDU is not required:
      3. instruct the physical layer to signal a positive acknowledgement on the PUCCH (to the gNB)
   2. else if HARQ feedback has been disabled for the MAC PDU and no sidelink grant is available for next retransmission(s) of the MAC PDU:
      3. instruct the physical layer to signal a negative acknowledgement on the PUCCH (to the gNB).
   2. else [3]:
      3. if the MAC PDU is transmitted in unicast:
         4. if the physical layer detects PSFCH associated to the PSSCH transmission of the MAC PDU,
         5. instruct the physical layer to signal an acknowledgement info with the same value as that detected in PSFCH on the PUCCH (to the gNB).
         4. else,
         5. instruct the physical layer to signal a negative acknowledgement on the PUCCH (to the gNB).
      3. else if the MAC PDU is transmitted in groupcast and positive-negative acknowledgement (i.e., groupcast HARQ option 2) is adopted:
         4. if the physical layer detects positive acknowledgement in all PSFCHs associated to the PSSCH transmission of the MAC PDU,
         5. instruct the physical layer to signal a positive acknowledgement info on the PUCCH (to the gNB).
         4. else,
         5. instruct the physical layer to signal a negative acknowledgement info on the PUCCH (to the gNB).
      3. else if the MAC PDU is transmitted in groupcast and negative only acknowledgement (i.e., groupcast HARQ option 1) is adopted:
         4. if the physical layer does not detect any PSFCH associated to the PSSCH transmission of the MAC PDU,
         5. instruct the physical layer to signal a positive acknowledgement on the PUCCH (to the gNB).
         4. else,
         5. instruct the physical layer to signal a negative acknowledgement on the PUCCH (to the gNB).

For mode 1 dynamic scheduling, when multiple resources are preserved for transmission of the same TB, the UE signals the HARQ acknowledgement info on the PUCCH that is after the last preserved resource according to PSFCH associated to the PSSCH transmission using one or more of the multiple resources if the MAC PDU is transmitted in unicast:
1. Else:
   2. instruct the physical layer to signal a positive acknowledgement on the PUCCH (to the gNB).

The MAC entity may be configured by RRC with an SL Discontinuous Reception (DRX) functionality that controls the UE's SCI (i.e., 1^{st} stage SCI and 2^{nd} stage SCI) monitoring activity for unicast (UC), groupcast (GC) and broadcast (BC).

RRC controls Sidelink DRX operation by configuring the following parameters:
sl-drx-onDurationTimer|sl-DRX-GC-BC-OndurationTimer: the duration at the beginning of an SL DRX cycle;
sl-drx-SlotOffset|the delay before starting the sl-drx-onDurationTimer|sl-DRX-GC-BC-OndurationTimer;
sl-drx-InactivityTimer|sl-DRX-GC-InactivityTimer (except for the SL broadcast communication): the duration after the first slot of SCI (i.e., 1^{st} stage SCI and 2^{nd} stage SCI) reception in which an SCI indicates a new SL transmission for the MAC entity;
sl-drx-RetransmissionTimer|sl-DRX-GC-RetransmissionTimer (per Sidelink process): the maximum duration until an SL retransmission is received;
sl-drx-StartOffset: the slot where the SL DRX cycle starts;
sl-drx-Cycle|sl-DRX-GC-BC-Cycle: the Sidelink DRX cycle;
sl-drx-HARQ-RTT-Timer (per Sidelink process): the minimum duration before an SL HARQ retransmission is expected by the MAC entity

Receiving (Rx) UE stops sl-drx-RetransmissionTimer|sl-DRX-GC-RetransmissionTimer if it receives a SCI indicates an UC/GC SL transmission where it is a target receiver, it starts sl-drx-RetransmissionTimer|sl-DRX-GC-RetransmissionTimer when sl-drx-HARQ-RTT-Timer expires and the SL transmission is not correctly decoded.

sl-drx-HARQ-RTT-Timer is started following the end of the PSSCH transmission if HARQ feedback is disabled or the end of the PSFCH resource associated to the PSSCH transmission if HARQ feedback is enabled (no matter the PSFCH is actually transmitted or not).

Moreover, if the next retransmission opportunity is indicated in the SCI (this is the case when multiple resources are preserved for transmission of the same TB), sl-drx-HARQ-RTT-Timer is derived from the retransmission resource timing of the next retransmission resource in the SCI, otherwise sl-drx-HARQ-RTT-Timer is set to the value configured by higher layer if PSFCH resource is configured or 0 if PSFCH resource is not configured.

When sl-drx-RetransmissionTimer|sl-DRX-GC-RetransmissionTimer is running, the Rx UE is in active time.

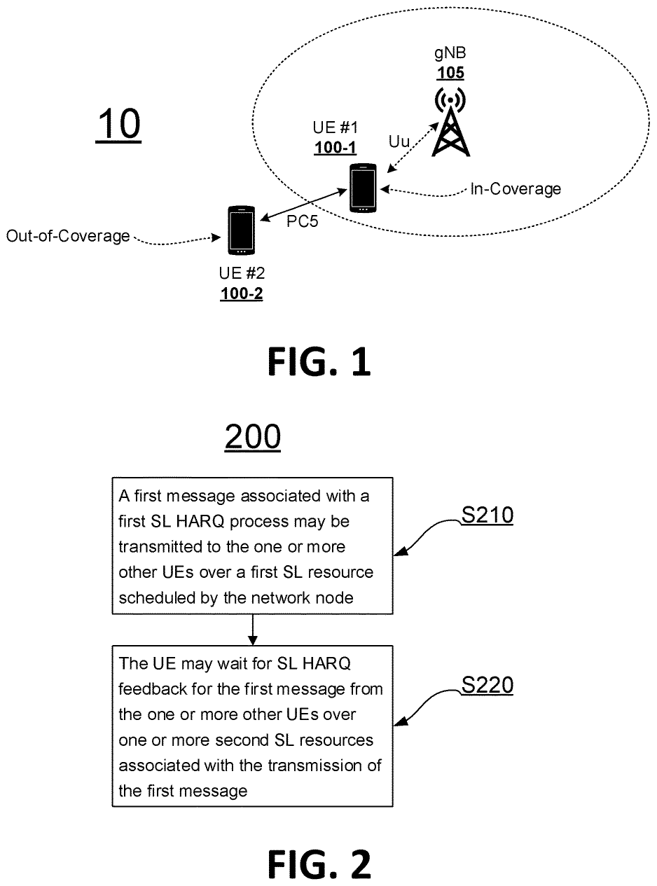

FIG. 1 is a diagram illustrating an exemplary network 10 in which sidelink communication with multiple feedback resources may be applicable according to an embodiment of the present disclosure. Although the network 10 is a network defined in the context of 5G NR, the present disclosure is not limited thereto.

As shown in FIG. 1, the network 10 may comprise one or more UEs 100-1 and 100-2 (collectively, UE(s) 100) and optionally a Radio Access Network (RAN) node 105, which could be a base station, a Node B, an evolved NodeB (eNB), a gNB, or an AN node which provides the UE ·0 1 100-1 with access to the network 10. Further, the network 10 may comprise other nodes and/or entities that are not shown in FIG. 1, for example (but not limited to) an Access & Mobility Management Function (AMF), a Session Management Function (SMF), a Policy Control Function (PCF), and/or a User Plane Function (UPF). Further, as shown in FIG. 1, the UEs 100 may communicate with each other via sidelinks over the reference point PC5, and the UE 100-1 may communicate with the gNB 105 over the reference point Uu. As also shown in FIG. 1, the UE 100-1 may be located in the coverage of the gNB 105 and served by the gNB 105 while the UE 100-2 may be out of coverage of the gNB 105 and not served by the gNB 105.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure. For example, in some embodiments, there is no gNB or there are one or more gNBs that serve some or all of the UEs 100, respectively.

In the 3GPP Rel.18, a Work Item (WI) on sidelink enhancement has been approved (RP-213678), which is incorporated herein by reference in its entirety, and one of the objectives is to study and specify support of sidelink on unlicensed spectrum (SL-U).

On unlicensed spectrum, PSFCH transmission is likely to be dropped due to LBT failure. To address this issue RAN1 are studying several solutions, where the solution with the most support is to associate more than 1 PSFCH occasion (or generally speaking, more than 1 feedback resource) to each PSCCH/PSSCH transmission, so that if a PSFCH transmission is dropped due to LBT failure among one of the multiple PSFCH occasions, it may be transmitted in the next PSFCH occasion if there is still PSFCH occasion(s) remaining, thus reducing the impact of LBT failure. Also, the Transmitting (Tx) UE is expected to handle HARQ retransmission for a HARQ process according to the following:
The TX UE performs a retransmission for the HARQ process if the TX UE receives NACK for that HARQ process on any of the PSFCH occasions,
For the TX UE with UC and GC with HARQ feedback option 2, the Tx UE performs retransmission if the TX UE does not receive HARQ feedback on all the expected PSFCH occasion(s).

However, introducing multiple PSFCH occasions may cause some issues:
Currently Tx UE sends HARQ info to gNB based on detection of HARQ feedback in a single PSFCH occasion. When there are multiple PSFCH occasions it is not clear how Tx UE should derive and send HARQ info to gNB and how Tx UE should handle the sidelink grant from the gNB in case the Tx UE is not expected to perform retransmission if Tx UE has not detected HARQ feedback while there are still PSFCH occasion(s) remained).
Currently sl-drx-RetransmissionTimer| sl-DRX-GC-RetransmissionTimer is started when sl-drx-HARQ-RTT-Timer expires and the SL transmission is not correctly decoded. However, with multiple PSFCH occasions, TX UE needs not to perform retransmission if HARQ feedback is not received and there are still PSFCH occasion(s) remained, in this case starting sl-drx-RetransmissionTimer| sl-DRX-GC-RetransmissionTimer just increases the power consumption of the Rx UE with no benefit.

Therefore, it is necessary to study the above issues and develop corresponding solutions.

Some embodiments of the present disclosure propose mechanisms to operate mode 1 scheduling and SL DRX with multiple PSFCH occasions in unlicensed spectrum where a PSFCH transmission may be dropped due to LBT failure and is transmitted in a following PSFCH occasion.

In some embodiments, the following aspects are provided:
TX UE actions when HARQ feedback is not received and there are still available PSFCH occasion(s)/PUCCH resource(s), such as how to handle the granted resource and whether/how to send feedback to the gNB.
gNB actions when there are still available PSFCH occasion(s)/PUCCH resource(s) associated to a granted SL resource, such as whether/how to treat the feedback sent by the Tx UE and whether/how to issue new grant to the Tx UE.
Rx UE actions on SL DRX when there are multiple PSFCH occasions, such as introducing a new timer, set its length based on the time distance between the multiple PSFCH occasions and start SL DRX RTT Timer when the new timer expires.

With the methods proposed in some embodiments, it is avoided that Tx UE performs unnecessary retransmission and gNB provides grant to the Tx UE where the grant is not really needed (thus is wasted). Moreover, SL DRX Retransmission Timer may be started only when the Rx UE needs to monitor the retransmission, thus avoids unnecessary power consumption increase at the Rx UE.

Some embodiments of the present disclosure are described in the context of NR sidelink (SL) communications in an unlicensed carrier. However, most of the embodiments are in general applicable to any kind of direct communications between UEs involving device-to-device (D2D) communications such as LTE SL in an unlicensed carrier. Embodiments are described from a TX UE and RX UE point of view. Further, in some embodiments, it is assumed that an SL UE and its serving gNB (if the UE is in network (NW) coverage) may operate with the same radio access technology (RAT), e.g., NR, LTE, and so on. However, all the embodiments may apply without loss of meaning to any combination of RATs between the SL UE and its serving gNB.

In some embodiments, the link or radio link over which the signals are transmitted between at least two UEs for D2D operation may be called herein as the sidelink (SL). In some embodiments, the signals transmitted between the UEs for D2D operation may be called herein as SL signals. In some embodiments, the term SL may also interchangeably be called as D2D link, V2X link, prose link, peer-to-peer link, PC5 link etc. In some embodiments, the SL signals may also interchangeably be called as V2X signals, D2D signals, prose signals, PC5 signals, peer-to-peer signals etc.

Besides, in some embodiments, the unlicensed SL carrier can be in any unlicensed band, e.g., 2.5, 5, 6 GHZ, FR1, FR2, 52.6 GHZ-71 GHZ, or beyond 100 GHz.

In the below embodiments, it is assumed that HARQ feedback is enabled if not otherwise declared.

In some embodiments, in mode 1, a Tx UE may ignore an SL grant/resource for a retransmission of a HARQ process if the Tx UE are still waiting for SL HARQ feedback on one or multiple PSFCH occasions. More specifically, in some embodiments, the Tx UE may ignore the SL grant/resource for a retransmission in a HARQ process if the SL HARQ feedback for the latest SL transmission in the HARQ process has not been received and there are still available PSFCH occasion(s) associated to that latest SL transmission.

In some embodiments, if the Tx UE is allowed/configured by the NW to select the HARQ process for its transmission by itself, if the SL HARQ feedback for the latest SL transmission in a HARQ process has not been received and there are still available PSFCH occasion(s) associated to the SL transmission, the Tx UE may use an SL grant/resource(s) obtained via Mode 1 scheduling for retransmission(s) or new transmission(s) in a different HARQ process. In some embodiments, the HARQ process may be selected in the following order:
1. Retransmission(s) in a HARQ process where SL HARQ feedback for the latest SL transmission in the HARQ process has not been received and there are no more available PSFCH occasion associated to the SL transmission
2. Retransmission(s) in a HARQ process where negative SL HARQ feedback for the latest SL transmission in the HARQ process has been received.
3. (Re) transmission in a HARQ process where there is no buffered SL traffic or Initial transmission and retransmission(s) in a HARQ process where positive SL HARQ feedback for the latest SL transmission in the HARQ process has been received.

In some embodiments, in mode 1, if the Tx UE has not detected SL HARQ feedback in a PSFCH occasion associated to the latest PSSCH transmission in a HARQ process, and there are still available PSFCH occasion(s) associated to the SL transmission, the Tx UE may do any of the followings:
does not send HARQ feedback to the gNB.
sends NACK to the gNB, even when the corresponding PSSCH transmission is a groupcast transmission with HARQ option 1 (i.e., negative only acknowledgement).
indicates “no HARQ feedback is detected” or “waiting for SL HARQ feedback” to the gNB. This can be achieved via e.g., a field in the UCI or MAC CE. In some embodiments, the signalling may also carry the associated HARQ process IDs, i.e., indicating the HARQ process(es) for which the Tx UE has not detected HARQ feedback.

On the other hand, in some embodiments, if the Tx UE does not detect SL HARQ feedback in a PSFCH occasion associated to the latest PSSCH transmission in a HARQ process, and there are no more PSFCH occasion associated to the SL transmission, the Tx UE may react similar as in the legacy, i.e.:
send NACK to the gNB
send NACK to the gNB if the SL transmission is a unicast transmission or a groupcast transmission with HARQ option 2 (i.e., positive-negative acknowledgement)
else send ACK to the gNB if the SL transmission is a groupcast transmission with HARQ option 1 (i.e., negative only acknowledgement)

In some embodiments, the gNB may configure/indicate multiple PUCCH and/or PUSCH resources for sending HARQ feedback for a SL transmission when there are multiple PSFCH occasions. For instance, suppose there are M (M>1) PSFCH occasions associated to a PSSCH transmission, N PUCCH/PUSCH resources may be configured/indicated for the PSSCH transmission, where M>=N>1. In some embodiments, the last PUCCH/PUSCH resources may be after the last PSFCH occasion while the other PUCCH/PUSCH resource(s) may be between the first and the last PSFCH occasion.

In some embodiments, for a non-last PUCCH/PUSCH resource associated to a PSSCH transmission, if the Tx UE has not detected SL HARQ feedback before the PUCCH/PUSCH resource, the Tx UE may perform similar as described above, i.e., not indicate HARQ info, indicate NACK or “no HARQ feedback is detected” or “waiting for SL HARQ feedback” in the PUCCH/PUSCH resource, otherwise the Tx UE may send HARQ info in the PUCCH/PUSCH resource based on the detected SL HARQ feedback as in legacy. In some embodiments, for the last PUCCH/PUSCH resource associated to a PSSCH transmission, if the Tx UE has not detected SL HARQ feedback in all the PSFCH occasion(s) associated to the PSSCH transmission, the Tx UE may send NACK to gNB for PSSCH transmission, or send NACK to gNB for PSSCH transmission in unicast or in groupcast with HARQ option 2 and ACK for PSSCH transmission in groupcast with HARQ option 1 in the PUCCH/PUSCH resource, otherwise the Tx UE may send HARQ info in the PUCCH/PUSCH resource based on the detected SL HARQ feedback as in legacy.

In some embodiments, at a time T, the gNB may do any one or more of the followings if the latest feedback from the Tx UE indicates that “no HARQ feedback is received” or the gNB has not received ACK corresponding to SL transmission using the latest SL resource granted before the time T in a SL HARQ process (the SL transmission may or may not be actually performed) and there are still available PSFCH occasion(s) or PUCCH/PUSCH resource(s) associated to the granted SL resource:
Ignore the HARQ info (e.g. NACK) detected in the PUCCH/PUSCH resource associated to the SL resource.
Do not issue a new SL grant to the Tx UE (for the associated HARQ process).
Issue a new SL grant to the Tx UE for (re) transmission in another SL HARQ process.
   In some embodiments, the Tx UE may drop the remaining resource(s) in the current SL grant. In some embodiments, the Tx UE may continue to use the remaining resource(s) in the current SL grant for retransmission(s) in the SL HARQ process in case retransmission(s) need to be performed. In some embodiments, which option to adopt could be configured by the gNB, preconfigured at UE, or hard coded in the spec.

On the other hand, in some embodiments, at a time T, if the gNB has not received ACK to SL transmission using the latest SL resource granted before the time T in an SL HARQ process (the SL transmission may or may not be actually performed) and there are no more available PSFCH occasion(s) or PUCCH/PUSCH resource(s) associated to the granted SL resource, the gNB may issue a new SL grant for retransmission(s) in the SL HARQ process to the Tx UE.

In some embodiments, the gNB may only do the above when there are no more preserved resource(s) for the SL HARQ process after the time T.

In some embodiments, in order to identify whether there are still available PSFCH occasion(s) associated to a granted SL resource for a SL HARQ process, for each Tx UE using mode 1 the gNB may maintain a counter for each SL HARQ process of the Tx UE and do the followings:
Restart the counter after each granted SL resource for the SL HARQ process and initially set it to 0.
Increase the counter by one after each PSFCH occasion associated to the SL resource
Determine that there are still available PSFCH occasion(s) associated to a granted SL resource for the SL HARQ process if the counter value is less than the total number of PSFCH occasion(s) for the PSSCH transmission where this total number may be configured by RRC or indicated in DCI.

In some embodiments, for SL DRX, an additional timer may be introduced to cope with multiple PSFCH occasions. E.g., the timer may be denoted as sl-drx-HARQ-PSFCH-Timer. In some embodiments, the sl-drx-HARQ-PSFCH-Timer may be defined for each SL HARQ process and its length may be set based on the time distance between the multiple PSFCH occasions. For instance, suppose there are N (N>1) PSFCH occasions associated to a PSSCH transmission and the time distance between two adjacent PSFCH occasions is K ms, the length of sl-drx-HARQ-PSFCH-Timer may be set to (N−1)*K ms.

For a HARQ process, the Rx UE maintains the timers according to the followings:
Start sl-drx-HARQ-PSFCH-Timer following the end of the first PSFCH occasion associated to the latest received PSSCH transmission in the HARQ process if HARQ feedback is enabled.
Stop sl-drx-HARQ-PSFCH-Timer following the end of a PSFCH occasion associated to the latest received PSSCH transmission in the HARQ process where ACK is transmitted in that PSFCH occasion.
sl-drx-HARQ-RTT-Timer is started following the end of the received PSSCH transmission in the HARQ process if HARQ feedback is disabled, or following the PSFCH resource, in which the PSFCH is actually transmitted, associated to the received PSSCH transmission in the HARQ process if HARQ feedback is enabled, or upon sl-drx-HARQ-PSFCH-Timer is expired.
start sl-drx-RetransmissionTimer|sl-DRX-GC-RetransmissionTimer when sl-drx-HARQ-RTT-Timer expires and the latest received SL transmission in the HARQ process is not correctly decoded (similar as in legacy).

By this the sl-drx-RetransmissionTimer|sl-DRX-GC-RetransmissionTimer is started only when the Tx UE needs to perform retransmission and thus the Rx UE needs to monitor retransmission, consequently avoids unnecessary power consumption increase at Rx UE.

FIG. 2 is a flow chart of an exemplary method 200 at a UE for performing SL communication, which is scheduled by a network node, with one or more other UEs according to an embodiment of the present disclosure. The method 200 may be performed at a terminal device (e.g., the UE 100-1). The method 200 may comprise steps S210 and S220. However, the present disclosure is not limited thereto. In some other embodiments, the method 200 may comprise more steps, less steps, different steps, or any combination thereof. Further the steps of the method 200 may be performed in a different order than that described herein when multiple steps are involved. Further, in some embodiments, a step in the method 200 may be split into multiple sub-steps and performed by different entities, and/or multiple steps in the method 200 may be combined into a single step.

The method 200 may begin at step S210 where a first message associated with a first SL HARQ process may be transmitted to the one or more other UEs over a first SL resource scheduled by the network node.

At step S220, the UE may wait for SL HARQ feedback for the first message from the one or more other UEs over one or more second SL resources associated with the transmission of the first message.

In some embodiments, the method 200 may further comprise: determining whether the UE is still waiting for the SL HARQ feedback for the first message over at least one of the one or more second SL resources or not. In some embodiments, the step of determining whether the UE is still waiting for the SL HARQ feedback for the first message over at least one of the one or more second SL resources or not may comprise: determining whether the SL HARQ feedback for the first message has been received or not; determining whether at least one of the one or more second SL resources is still available for the SL HARQ feedback or not; and determining that the UE is still waiting for the SL HARQ feedback for the first message over the at least one of the one or more second SL resources in response to determining that the SL HARQ feedback for the first message has not been received from at least one of the one or more other UEs and in response to determining that the at least one of the one or more second SL resources is still available for the SL HARQ feedback. In some embodiments, the method 200 may further comprise: determining that the UE is not waiting for the SL HARQ feedback for the first message over the at least one of the one or more second SL resources in response to determining that the SL HARQ feedback for the first message has been received from all of the one or more other UEs and/or in response to determining that none of the second SL resources is still available for the SL HARQ feedback.

In some embodiments, before the step of determining whether the UE is still waiting for the SL HARQ feedback for the first message over at least one of the one or more second SL resources or not, the method 200 may further comprise: receiving, from the network node, a message indicating one or more third SL resources for retransmission of the first message. In some embodiments, the method 200 may further comprise at least one of: ignoring at least one of the one or more third SL resources in response to determining that the UE is still waiting for the SL HARQ feedback over at least one of the one or more second SL resources; and transmitting a second message associated with a second SL HARQ process, which is different from the first SL HARQ process, over the one or more third SL resources when the UE is allowed and/or configured to select a HARQ process for its transmission by itself. In some embodiments, before the step of transmitting the second message, the method 200 may further comprise: selecting, as the second SL HARQ process, one of SL HARQ processes in a following listed order, the SL HARQ processes comprising at least one of: an SL HARQ process where SL HARQ feedback for the latest SL transmission associated with the SL HARQ process has not been received, there is no more available SL resource for the SL HARQ feedback, and associated retransmission is to be performed; an SL HARQ process where negative SL HARQ feedback for the latest SL transmission associated with the SL HARQ process has been received and associated retransmission is to be performed; and an SL HARQ process with no buffered SL traffic to be transmitted or retransmitted or an SL HARQ process where positive SL HARQ feedback for the latest SL transmission associated with the SL HARQ process has been received and initial transmission and one or more subsequent retransmissions are to be performed.

In some embodiments, the method 200 may further comprise, in response to determining that the UE is still waiting for the SL HARQ feedback for the first message over the at least one of the one or more second SL resources, at least one of: preventing a HARQ feedback for the first message from being transmitted to the network node; transmitting, to the network node, a message indicating a negative HARQ feedback for the first message; and transmitting, to the network node, a message indicating that the UE is waiting for SL HARQ feedback from at least one of the one or more other UEs for the first message. In some embodiments, the message indicating that the UE is waiting for SL HARQ feedback from at least one of the one or more other UEs for the first message may be Uplink Control Information (UCI) or a Medium Access Control (MAC) Control Element (CE). In some embodiments, the message indicating that the UE is waiting for SL HARQ feedback from at least one of the one or more other UEs for the first message may further indicate an identifier (ID) of the first SL HARQ process.

In some embodiments, the method 200 may further comprise, in response to determining that the UE is not waiting for the SL HARQ feedback for the first message over the at least one of the one or more second SL resources, at least one of: transmitting, to the network node, a message indicating a negative HARQ feedback for the first message; transmitting, to the network node, a message indicating a negative HARQ feedback for the first message when the transmission of the first message is a unicast transmission or a groupcast transmission with HARQ option 2; and transmitting, to the network node, a message indicating a positive HARQ feedback for the first message when the transmission of the first message is a groupcast transmission with HARQ option 1.

In some embodiments, when there are multiple second SL resources available for the UE to detect SL HARQ feedback, the method 200 may further comprise: receiving, from the network node, a message indicating multiple uplink (UL) resources for the UE to transmit, to the network node, HARQ feedback for the first message. In some embodiments, the number of the multiple UL resources may be less than or equal to the number of the multiple second SL resources. In some embodiments, the last one of the multiple UL resources may occur later than the last one of the multiple second SL resources, and the non-last ones of the multiple UL resources may occur between the first one and the last one of the multiple second SL resources. In some embodiments, for a non-last one of the multiple UL resources, the method 200 may further comprise, in response to determining that the SL HARQ feedback for the first message has not been received from at least one of the one or more other UEs before the non-last UL resource, at least one of: preventing a HARQ feedback for the first message from being transmitted to the network node; transmitting, to the network node over the non-last one of the multiple UL resources, a message indicating a negative HARQ feedback for the first message; and transmitting, to the network node over the non-last one of the multiple UL resources, a message indicating that the UE is waiting for SL HARQ feedback from at least one of the one or more other UEs for the first message. In some embodiments, for a non-last one of the multiple UL resources, the method 200 may further comprise: transmitting, to the network node, a message indicating HARQ feedback for the first message over the non-last one of the multiple UL resources based on at least the SL HARQ feedback for the first message in response to determining that the SL HARQ feedback for the first message has been received from all of the one or more other UEs before the non-last UL resource. In some embodiments, for the last one of the multiple UL resources, the method 200 may further comprise, in response to determining that the SL HARQ feedback for the first message has not been received from at least one of the one or more other UEs over all of the multiple second SL resources, at least one of: transmitting, to the network node, a message indicating a negative HARQ feedback for the first message over the last one of the multiple UL resources; and transmitting, to the network node, a message indicating a negative HARQ feedback for the first message over the last one of the multiple UL resources when the transmission of the first message is a unicast transmission or a groupcast transmission with HARQ option 2; and transmitting, to the network node, a message indicating a positive HARQ feedback for the first message over the last one of the multiple UL resources when the transmission of the first message is a groupcast transmission with HARQ option 1. In some embodiments, for the last one of the multiple UL resources, the method 200 may further comprise: transmitting, to the network node, a message indicating HARQ feedback for the first message over the last one of the multiple UL resources based on at least the SL HARQ feedback for the first message in response to determining that the SL HARQ feedback for the first message has been received from all of the one or more other UEs over at least one of the one or more second SL resources.

In some embodiments, the method 200 may further comprise: receiving, from the network node, a fifth message indicating one or more fourth SL resources for transmission associated with a third SL HARQ process different from the first SL HARQ process, and the method 200 may further comprise at least one of: dropping remaining resources associated with the first SL HARQ process; and continuing to use the remaining resources associated with the first SL HARQ process for retransmission associated with the first SL HARQ process when retransmission needs to be performed. In some embodiments, whether the UE drops remaining resources associated with the first SL HARQ process and/or whether the UE continues to use the remaining resources may be determined in at least one of followings way: configured by the network node; preconfigured at the UE; and hard coded in the specification. In some embodiments, at least one of following may be true: the first SL resource is a resource for Physical Sidelink Control Channel (PSCCH) and/or Physical Sidelink Shared Channel (PSSCH) transmission; the one or more second SL resources are Physical Sidelink Feedback Channel (PSFCH) occasions; the one or more third SL resources are resources for PSSCH transmission; the one or more fourth SL resources are resources for PSSCH transmission; and the multiple UL resources are resources for Physical Uplink Control Channel (PUCCH) and/or Physical Uplink Shared Channel (PUSCH) transmission.

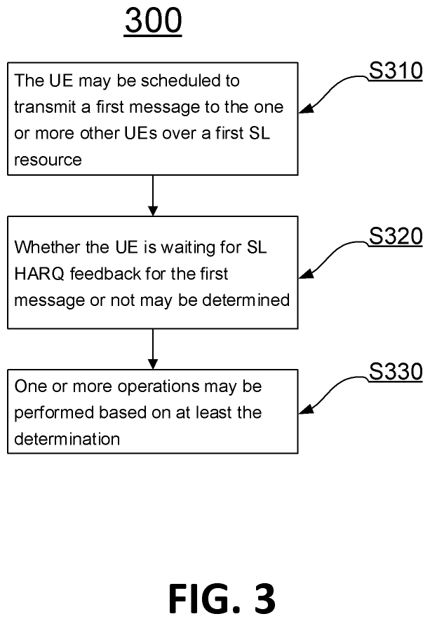

FIG. 3 is a flow chart of an exemplary method 300 at a network node for facilitating a UE in performing SL communication, which is scheduled by the network node, with one or more other UEs according to an embodiment of the present disclosure. The method 300 may be performed at a network node (e.g., the gNB 105).

The method 300 may comprise steps S310, S320, and S330. However, the present disclosure is not limited thereto. In some other embodiments, the method 300 may comprise more steps, less steps, different steps, or any combination thereof. Further the steps of the method 300 may be performed in a different order than that described herein when multiple steps are involved. Further, in some embodiments, a step in the method 300 may be split into multiple sub-steps and performed by different entities, and/or multiple steps in the method 300 may be combined into a single step.

The method 300 may begin at step S310 where the UE may be scheduled to transmit a first message to the one or more other UEs over a first SL resource.

At step S320, whether the UE is waiting for SL HARQ feedback for the first message or not may be determined.

At step S330, one or more operations may be performed based on at least the determination.

In some embodiments, the one or more operations may comprise at least one of: ignoring HARQ feedback received from the UE for the first message in response to determining that the UE is still waiting for the SL HARQ feedback for the first message; preventing a new SL grant from being issued to the UE for retransmission of the first message in response to determining that the UE is still waiting for the SL HARQ feedback for the first message; and issuing a new SL grant to the UE for transmission of a second message different from the first message in response to determining that the UE is still waiting for the SL HARQ feedback for the first message; and issuing a new SL grant to the UE for retransmission of the first message in response to determining that the UE is not waiting for the SL HARQ feedback for the first message. In some embodiments, the step of determining that the UE is still waiting for SL HARQ feedback for the first message may comprise at least one of: receiving, from the UE, a message indicating that the UE is waiting for SL HARQ feedback from at least one of the one or more other UEs for the first message; determining that the network node has not received HARQ feedback for the first message that should have been transmitted in the first SL resource and that there is still at least one second SL resource available for SL HARQ feedback associated to the first SL resource and/or at least one UL resource available for HARQ feedback associated to the first SL resource.

In some embodiments, the step of determining that the UE is not waiting for SL HARQ feedback for the first message may comprise: determining that the network node has not received positive HARQ feedback for the first message that should have been transmitted in the first SL resource and that there is no second SL resource available for SL HARQ feedback associated to the first SL resource and/or no UL resource available for HARQ feedback associated to the first SL resource. In some embodiments, the determination of whether the UE is waiting for SL HARQ feedback for the first message or not may be performed at a time before which the latest SL resource granted by the network node to the UE is the first SL resource. In some embodiments, the one or more operations may be performed only when there is no more preserved resource for the first message after the step of determining whether the UE is waiting for SL HARQ feedback for the first message or not.

In some embodiments, a counter may be maintained at the network node for an SL HARQ process for the UE. In some embodiments, the counter may be used by the network node to determine whether there is still at least one second SL resource available for SL HARQ feedback associated to a granted SL resource delivered to the SL HARQ process or not. In some embodiments, the counter may be initially set to 0 and reset to 0 after each granted SL resource delivered to the SL HARQ process occurs, and/or the counter may be increased by one after each second SL resource for SL HARQ feedback associated to a granted SL resource delivered to the SL HARQ process occurs. In some embodiments, the step of determining whether there is still at least one second SL resource available for SL HARQ feedback associated to a granted SL resource delivered to the SL HARQ process may comprise: determining whether the counter has a value less than a total number of second SL resources for SL HARQ feedback associated to the granted SL resource or not. In some embodiments, the step of determining whether there is still at least one second SL resource available for SL HARQ feedback associated to the granted SL resource may further comprise at least one of: determining that there is still at least one second SL resource available for SL HARQ feedback associated to the granted SL resource in response to determining that the counter has a value less than the total number of second SL resources for SL HARQ feedback associated to the granted SL resource; and determining that there is no second SL resource available for SL HARQ feedback associated to the granted SL resource in response to determining that the counter has a value equal to or greater than the total number of second SL resources for SL HARQ feedback associated to the granted SL resource. In some embodiments, at least one of following may be true: the first SL resource is a resource for PSCCH and/or PSSCH transmission; the at least one second SL resource is PSFCH occasions; and the at least one UL resource is a resource for PUCCH and/or PUSCH transmission.

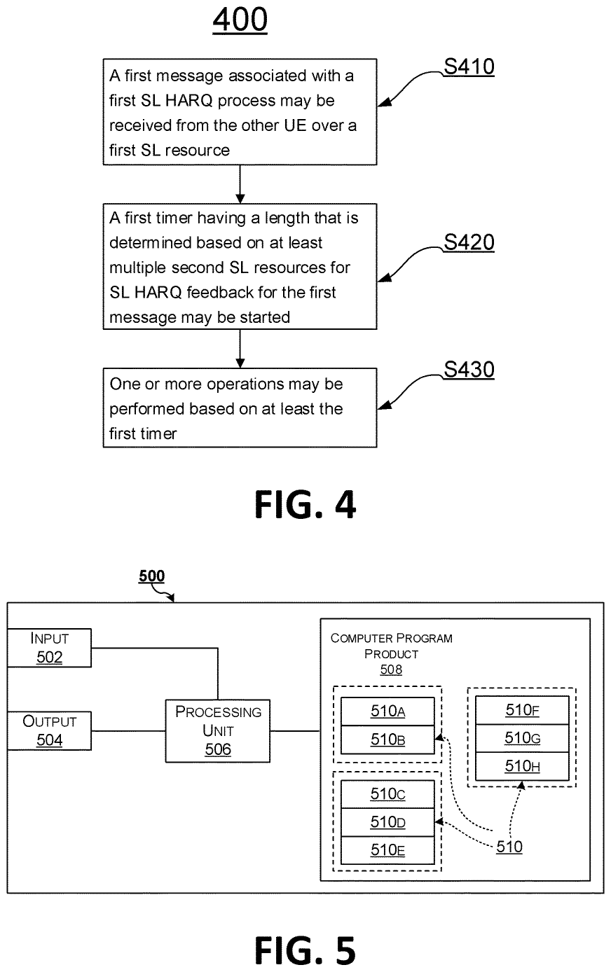

FIG. 4 is a flow chart of an exemplary method 400 at a UE for performing SL communication with another UE according to an embodiment of the present disclosure. The method 400 may be performed at a terminal device (e.g., the UE 100-2). The method 400 may comprise steps S410, S420, and S430. However, the present disclosure is not limited thereto. In some other embodiments, the method 400 may comprise more steps, less steps, different steps, or any combination thereof. Further the steps of the method 400 may be performed in a different order than that described herein when multiple steps are involved. Further, in some embodiments, a step in the method 400 may be split into multiple sub-steps and performed by different entities, and/or multiple steps in the method 400 may be combined into a single step.

The method 400 may begin at step S410 where a first message associated with a first SL HARQ process may be received from the other UE over a first SL resource.

At step S420, a first timer having a length that is determined based on at least multiple second SL resources for SL HARQ feedback for the first message may be started.

At step S430, one or more operations may be performed based on at least the first timer.

In some embodiments, the length of the first timer may be determined based on a time distance between the multiple second SL resources. In some embodiments, the length of the first timer may be determined as a time distance between one of the second SL resources that occurs the earliest and another of the second SL resources that occurs the latest. In some embodiments, the step of starting the first timer may be performed upon the end of one of the second SL resources that occurs the earliest when SL HARQ feedback is enabled. In some embodiments, the one or more operations may comprise at least one of: stopping the first timer upon the end of one of the second SL resources over which a positive SL HARQ feedback is transmitted to the other UE when SL HARQ feedback is enabled; starting a second timer upon the end of one of the second SL resources when SL HARQ feedback is enabled and the SL HARQ feedback for the first message is transmitted to the other UE in that second SL resource; starting the second timer upon the end of one of the second SL resources when SL HARQ feedback is enabled and the first timer expires; and starting a third timer upon the second timer expires and the received first message is not correctly decoded. In some embodiments, the method 400 may further comprise at least one of: starting the second timer upon the end of the reception of the first message when SL HARQ feedback is disabled. In some embodiments, at least one of following may be true: the first SL resource is a resource for PSCCH and/or PSSCH transmission; the multiple second SL resources are PSFCH occasions; the first timer is sl-drx-HARQ-PSFCH-Timer, the second timer is sl-drx-HARQ-RTT-Timer, and the third timer is sl-RetransmissionTimer and/or sl-DRX-GC-RetransmissionTimer.

FIG. 5 schematically shows an embodiment of an arrangement 500 which may be used in UEs (e.g., the UE 100-1 or the UE 100-2) or a network node (e.g., the gNB 105) according to an embodiment of the present disclosure. Comprised in the arrangement 500 are a processing unit 506, e.g., with a Digital Signal Processor (DSP) or a Central Processing Unit (CPU). The processing unit 506 may be a single unit or a plurality of units to perform different actions of procedures described herein. The arrangement 500 may also comprise an input unit 502 for receiving signals from other entities, and an output unit 504 for providing signal(s) to other entities. The input unit 502 and the output unit 504 may be arranged as an integrated entity or as separate entities.

Furthermore, the arrangement 500 may comprise at least one computer program product 508 in the form of a non-volatile or volatile memory, e.g., an Electrically Erasable Programmable Read-Only Memory (EEPROM), a flash memory and/or a hard drive. The computer program product 508 comprises a computer program 510, which comprises code/computer readable instructions, which when executed by the processing unit 506 in the arrangement 500 causes the arrangement 500 and/or the UE/network node in which it is comprised to perform the actions, e.g., of the procedure described earlier in conjunction with FIG. 2 through FIG. 4 or any other variant.

The computer program 510 may be configured as a computer program code structured in computer program modules 510A and 510B. Hence, in an exemplifying embodiment when the arrangement 500 is used in a UE for performing SL communication, which is scheduled by a network node, with one or more other UEs, the code in the computer program of the arrangement 500 includes: a module 510A configured to transmit, to the one or more other UEs, a first message associated with a first SL HARQ process over a first SL resource scheduled by the network node; and a module 510B configured to wait for SL HARQ feedback for the first message from the one or more other UEs over one or more second SL resources associated with the transmission of the first message.

Further, the computer program 510 may be further configured as a computer program code structured in computer program modules 510C, 510D, and 510E. Hence, in an exemplifying embodiment when the arrangement 500 is used in a network node for facilitating a UE in performing SL communication, which is scheduled by the network node, with one or more other UEs, the code in the computer program of the arrangement 500 includes: a module 510C configured to schedule the UE to transmit a first message to the one or more other UEs over a first SL resource; a module 510D configured to determine whether the UE is waiting for SL HARQ feedback for the first message or not; and a module 510E configured to perform one or more operations based on at least the determination.

Further, the computer program 510 may be further configured as a computer program code structured in computer program modules 510F, 510G, and 510H. Hence, in an exemplifying embodiment when the arrangement 500 is used in a UE for performing SL communication with another UE, the code in the computer program of the arrangement 500 includes: a module 510F configured to receive, from the other UE, a first message associated with a first SL HARQ process over a first SL resource; a module 510G configured to start a first timer having a length that is determined based on at least multiple second SL resources for SL HARQ feedback for the first message; and a module 510H configured to perform one or more operations based on at least the first timer.

The computer program modules could essentially perform the actions of the flow illustrated in FIG. 2 through FIG. 4, to emulate the UEs or the network node. In other words, when the different computer program modules are executed in the processing unit 506, they may correspond to different modules in the UEs or the network node.

Although the code means in the embodiments disclosed above in conjunction with FIG. 5 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UEs and/or the network node.

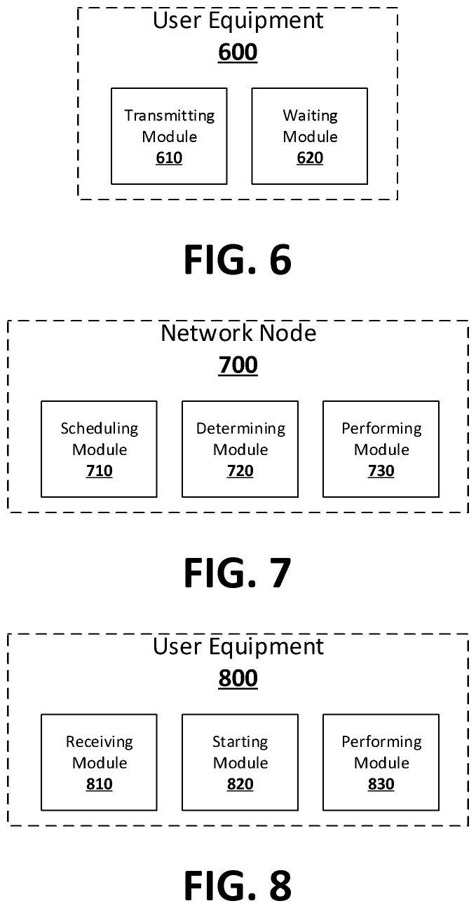

Correspondingly to the method 200 as described above, an exemplary UE is provided. FIG. 6 is a block diagram of a UE 600 according to an embodiment of the present disclosure. The UE 600 may be, e.g., the UE 100-1 in some embodiments.

The UE 600 may be configured to perform the method 200 as described above in connection with FIG. 2. As shown in FIG. 6, the UE 600 may comprise: a transmitting module 610 configured to transmit, to the one or more other UEs, a first message associated with a first SL HARQ process over a first SL resource scheduled by the network node; and a waiting module 620 configured to wait for SL HARQ feedback for the first message from the one or more other UEs over one or more second SL resources associated with the transmission of the first message.

The above modules 610 and/or 620 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2. Further, the UE 600 may comprise one or more further modules, each of which may perform any of the steps of the method 200 described with reference to FIG. 2.

Correspondingly to the method 300 as described above, a network node is provided. FIG. 7 is a block diagram of an exemplary network node 700 according to an embodiment of the present disclosure. The network node 700 may be, e.g., the gNB 105 in some embodiments.

The network node 700 may be configured to perform the method 300 as described above in connection with FIG. 3. As shown in FIG. 7, the network node 700 may comprise a scheduling module 710 configured to schedule the UE to transmit a first message to the one or more other UEs over a first SL resource; a determining module 720 configured to determine whether the UE is waiting for SL HARQ feedback for the first message or not; and a performing module 730 configured to perform one or more operations based on at least the determination.

The above modules 710, 720, and 730 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 3. Further, the network node 700 may comprise one or more further modules, each of which may perform any of the steps of the method 300 described with reference to FIG. 3.

Correspondingly to the method 400 as described above, an exemplary UE is provided. FIG. 8 is a block diagram of a UE 800 according to an embodiment of the present disclosure. The UE 800 may be, e.g., the UE 100-2 in some embodiments.

The UE 800 may be configured to perform the method 400 as described above in connection with FIG. 4. As shown in FIG. 8, the UE 800 may comprise: a receiving module 810 configured to receive, from the other UE, a first message associated with a first SL HARQ process over a first SL resource; a starting module 820 configured to start a first timer having a length that is determined based on at least multiple second SL resources for SL HARQ feedback for the first message; and a performing module 830 configured to perform one or more operations based on at least the first timer.

The above modules 810, 820, and/or 830 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 4. Further, the UE 800 may comprise one or more further modules, each of which may perform any of the steps of the method 400 described with reference to FIG. 4.

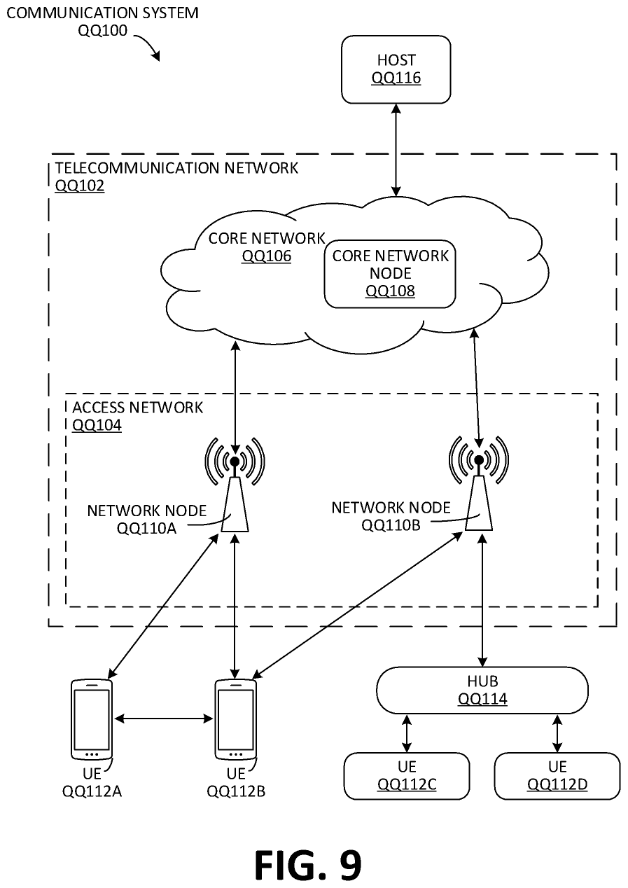

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

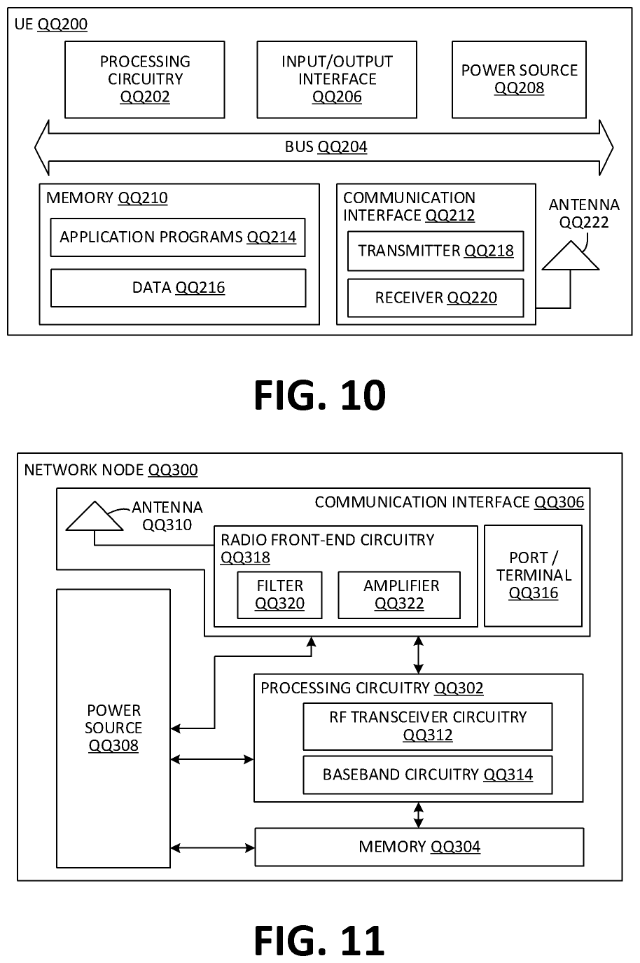

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

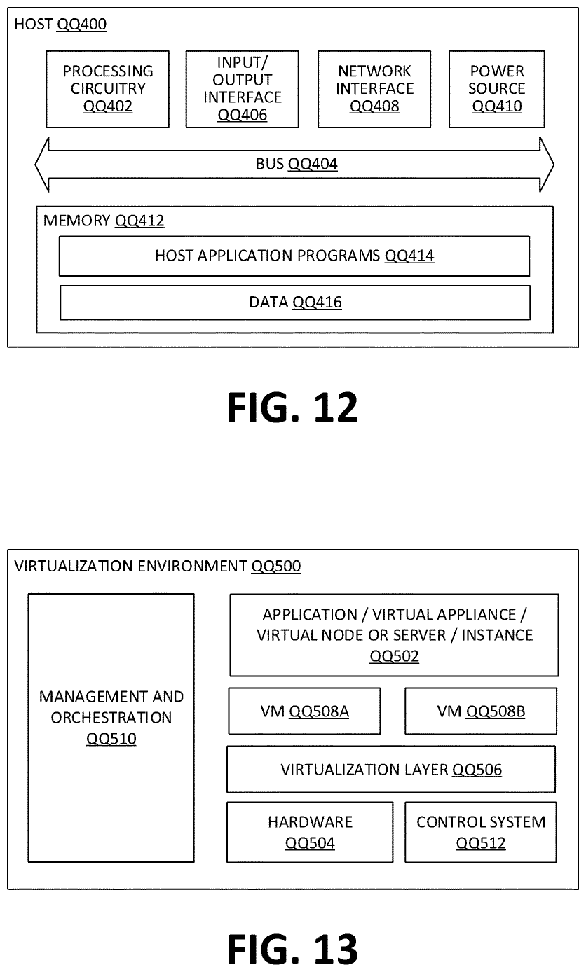

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 10 and FIG. 11, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

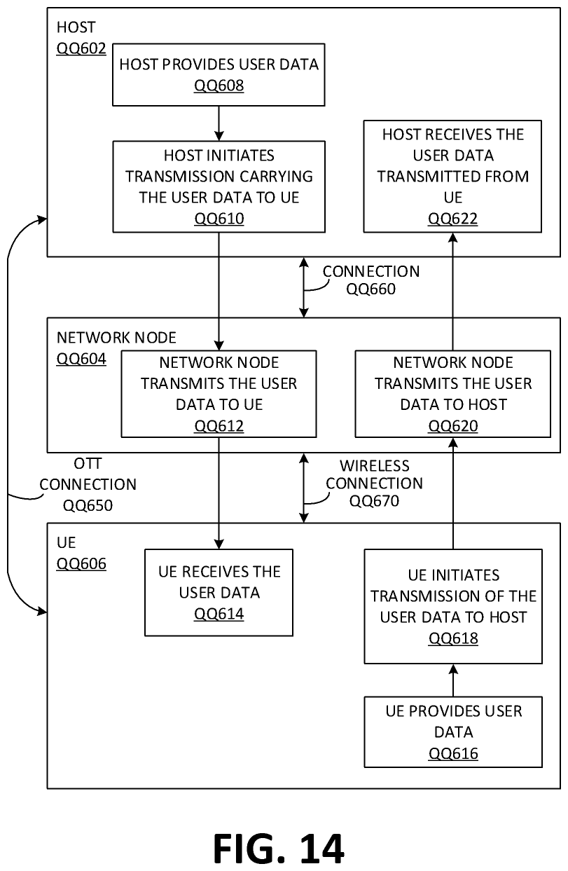

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9 and/or UE QQ200 of FIG. 10), network node (such as network node QQ110a of FIG. 9 and/or network node QQ300 of FIG. 11), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| CA | Carrier Aggregation |
| CBR | Channel Busy Ratio |
| CQI | Channel Quality Indicator |
| CSI | Channel State Information |
| DFN | Direct Frame Number |
| DL | Downlink |
| DRX | Discontinuous Reception |
| FDD | Frequency Division Duplex |
| GNSS | Global Navigation Satellite System |
| HARQ | Hybrid automatic repeat request |
| IE | Information Element |
| MAC | Medium Access Control |
| MIB | Master Information Block |
| NSPS | National Security and Public Safety |
| OoC | Out-of-Coverage |
| PDCCH | Physical Downlink Control Channel |
| PDCP | Packet Data Convergence Protocol |
| PDU | Protocol Data Unit |
| PHY | Physical (layer) |
| PL | Path Loss |
| PMI | Precoding Matrix Indicator |
| ProSe | Proximity Services |
| PSCCH | Physical Sidelink Control Channel |
| PSSCH | Physical Sidelink Shared Channel |
| RI | Rank Indicator |
| RL | Relay |
| RLC | Radio link control |
| RM | Remote |
| RRC | Radio Resource Control |
| RSRP | Reference Signal Received Power |
| RSSI | Received Signal Strength Indicator |
| RX | Receive, receiver |
| SFN | System Frame Number |
| SIB | System Information Block |
| SINR | Signal to interference noise ratio |
| SL | Sidelink |
| SLRB | Sidelink Radio Bearer |
| SLSS | Sidelink Synchronization Signals |
| SMF | Session Management Function |
| SynchUE | Synchronization UE |
| TA | Time advance |
| TDD | Time Division Duplex |
| TETRA | Terrestrial Trunked Radio |
| TX | Transmit, transmitter |
| UE | User Equipment |
| UL | Uplink |
| UPF | User Plane Function |
| V2V | Vehicle-to-vehicle |
| V2X | Vehicle-to-anything |

1-44. (canceled)

45. A method at a User Equipment (UE) for performing sidelink (SL) communication, which is scheduled by a network node, with one or more other UEs, the method comprising:
transmitting, to the one or more other UEs, a first message associated with a first SL hybrid automatic repeat request (HARQ) process over a first SL resource scheduled by the network node; and
waiting for SL HARQ feedback for the first message from the one or more other UEs over one or more second SL resources associated with the transmission of the first message.

46. The method of claim 45, further comprising determining whether the UE is still waiting for the SL HARQ feedback for the first message over at least one of the one or more second SL resources or not.

47. The method of claim 46, wherein the step of determining whether the UE is still waiting for the SL HARQ feedback for the first message over at least one of the one or more second SL resources or not comprises:
determining whether the SL HARQ feedback for the first message has been received or not;
determining whether at least one of the one or more second SL resources is still available for the SL HARQ feedback or not; and
determining that the UE is still waiting for the SL HARQ feedback for the first message over the at least one of the one or more second SL resources in response to determining that the SL HARQ feedback for the first message has not been received from at least one of the one or more other UEs and in response to determining that the at least one of the one or more second SL resources is still available for the SL HARQ feedback.

48. The method of claim 47, further comprising determining that the UE is not waiting for the SL HARQ feedback for the first message over the at least one of the one or more second SL resources in response to determining that the SL HARQ feedback for the first message has been received from all of the one or more other UEs and/or in response to determining that none of the second SL resources is still available for the SL HARQ feedback.

49. The method of claim 47, further comprising, in response to determining that the UE is not waiting for the SL HARQ feedback for the first message over the at least one of the one or more second SL resources, at least one of:
transmitting, to the network node, a message indicating a negative HARQ feedback for the first message;
transmitting, to the network node, a message indicating a negative HARQ feedback for the first message when the transmission of the first message is a unicast transmission or a groupcast transmission with HARQ option 2; and
transmitting, to the network node, a message indicating a positive HARQ feedback for the first message when the transmission of the first message is a groupcast transmission with HARQ option 1.

50. The method of claim 46, wherein before the step of determining whether the UE is still waiting for the SL HARQ feedback for the first message over at least one of the one or more second SL resources or not, the method further comprises receiving, from the network node, a message indicating one or more third SL resources for retransmission of the first message.

51. The method of claim 50, further comprising at least one of:
ignoring at least one of the one or more third SL resources in response to determining that the UE is still waiting for the SL HARQ feedback over at least one of the one or more second SL resources; and
transmitting a second message associated with a second SL HARQ process, which is different from the first SL HARQ process, over the one or more third SL resources when the UE is allowed and/or configured to select a HARQ process for its transmission by itself.

52. The method of claim 51, wherein before the step of transmitting the second message, the method further comprises:
selecting, as the second SL HARQ process, one of SL HARQ processes in a following listed order, the SL HARQ processes comprising at least one of:
an SL HARQ process where SL HARQ feedback for the latest SL transmission associated with the SL HARQ process has not been received, there is no more available SL resource for the SL HARQ feedback, and associated retransmission is to be performed;
an SL HARQ process where negative SL HARQ feedback for the latest SL transmission associated with the SL HARQ process has been received and associated retransmission is to be performed; and
an SL HARQ process with no buffered SL traffic to be transmitted or retransmitted or an SL HARQ process where positive SL HARQ feedback for the latest SL transmission associated with the SL HARQ process has been received and initial transmission and one or more subsequent retransmissions are to be performed.

53. The method of claim 46, further comprising, in response to determining that the UE is still waiting for the SL HARQ feedback for the first message over the at least one of the one or more second SL resources, at least one of:
preventing a HARQ feedback for the first message from being transmitted to the network node;
transmitting, to the network node, a message indicating a negative HARQ feedback for the first message; and
transmitting, to the network node, a message indicating that the UE is waiting for SL HARQ feedback from at least one of the one or more other UEs for the first message;
wherein the message indicating that the UE is waiting for SL HARQ feedback from at least one of the one or more other UEs for the first message is Uplink Control Information (UCI) or a Medium Access Control (MAC) Control Element (CE); wherein the message indicating that the UE is waiting for SL HARQ feedback from at least one of the one or more other UEs for the first message further indicates an identifier (ID) of the first SL HARQ process.

54. The method of claim 45, wherein when there are multiple second SL resources available for the UE to detect SL HARQ feedback, the method further comprises:
receiving, from the network node, a message indicating multiple uplink (UL) resources for the UE to transmit, to the network node, HARQ feedback for the first message; wherein the number of the multiple UL resources is less than or equal to the number of the multiple second SL resources; wherein the last one of the multiple UL resources occurs later than the last one of the multiple second SL resources, and
wherein the non-last ones of the multiple UL resources occur between the first one and the last one of the multiple second SL resources.

55. The method of claim 54, wherein for a non-last one of the multiple UL resources, the method further comprises, in response to determining that the SL HARQ feedback for the first message has not been received from at least one of the one or more other UEs before the non-last UL resource, at least one of:
preventing a HARQ feedback for the first message from being transmitted to the network node;
transmitting, to the network node over the non-last one of the multiple UL resources, a message indicating a negative HARQ feedback for the first message; and
transmitting, to the network node over the non-last one of the multiple UL resources, a message indicating that the UE is waiting for SL HARQ feedback from at least one of the one or more other UEs for the first message.

56. The method of claim 45, wherein at least one of following is true:
the first SL resource is a resource for Physical Sidelink Control Channel (PSCCH) and/or Physical Sidelink Shared Channel (PSSCH) transmission;
the one or more second SL resources are Physical Sidelink Feedback Channel (PSFCH) occasions;
the one or more third SL resources are resources for PSSCH transmission;
the one or more fourth SL resources are resources for PSSCH transmission; and
the multiple UL resources are resources for Physical Uplink Control Channel (PUCCH) and/or Physical Uplink Shared Channel (PUSCH) transmission.

57. A network node, comprising:
a memory storing instructions; and
a processor configured to execute the instructions, whereby the processor is configured to:
schedule the UE to transmit a first message to the one or more other UEs over a first SL resource;
determine whether the UE is waiting for SL HARQ feedback for the first message or not; and
perform one or more operations based on at least the determination.

58. A method at a UE for performing SL communication with another UE, the method comprising:
receiving, from the other UE, a first message associated with a first SL HARQ process over a first SL resource; and
starting a first timer having a length that is determined based on at least multiple second SL resources for SL HARQ feedback for the first message; and
performing one or more operations based on at least the first timer.

59. The method of claim 58, wherein the length of the first timer is determined based on a time distance between the multiple second SL resources.

60. The method of claim 58, wherein the length of the first timer is determined as a time distance between one of the second SL resources that occurs the earliest and another of the second SL resources that occurs the latest.

61. The method of claim 58, wherein the step of starting the first timer is performed upon the end of one of the second SL resources that occurs the earliest when SL HARQ feedback is enabled.

62. The method of claim 58, wherein the one or more operations comprise at least one of:
stopping the first timer upon the end of one of the second SL resources over which a positive SL HARQ feedback is transmitted to the other UE when SL HARQ feedback is enabled;
starting a second timer upon the end of one of the second SL resources when SL HARQ feedback is enabled and the SL HARQ feedback for the first message is transmitted to the other UE in that second SL resource;
starting the second timer upon the end of one of the second SL resources when SL HARQ feedback is enabled and the first timer expires; and
starting a third timer upon the second timer expires and the received first message is not correctly decoded.

63. The method of claim 58, further comprising starting the second timer upon the end of the reception of the first message when SL HARQ feedback is disabled.

64. The method of claim 58, wherein at least one of following is true:
the first SL resource is a resource for PSCCH and/or PSSCH transmission;
the multiple second SL resources are PSFCH occasions;
the first timer is sl-drx-HARQ-PSFCH-Timer;
the second timer is sl-drx-HARQ-RTT-Timer; and
the third timer is sl-RetransmissionTimer and/or sl-DRX-GC-RetransmissionTimer.
